(19) United States
(12) Patent Application Publication
(10) Pub. No.: US 2019/0375505 A1
(43) Pub. Date: Dec. 12, 2019

(54) Detachable Pilotable Capsules and Aircrafts Including Detachable Pilotable Capsules

(71) Applicant: A.L.D. ADVANCED LOGISTICS DEVELOPMENT LTD., Tel Aviv (IL)

(72) Inventors: Zigmund Bluvband, Rishon Le-Zion (IL); Emanuel Kushnir, Rehovot (IL); Gleb Asnin, Petah Tiqwa (IL)

(21) Appl. No.: 16/222,216

(22) Filed: Dec. 17, 2018

Related U.S. Application Data
(63) Continuation of application No. 14/945,453, filed on Nov. 19, 2015, now abandoned.

(51) Int. Cl. B64D 5/00; B64C 3/46; B64C 39/06

(52) U.S. Cl. CPC B64D 5/00; B64C 13/18; B64C 39/062; B64C 3/46

(57) ABSTRACT

The present invention includes pilotable capsules, detachable from an aircraft and aircrafts including such capsules. According to some embodiments, there may be provided one or more capsules capable of flight and designed to detachably connect to an aircraft. According to some embodiments, detachable capsules may be designed to carry cargo and/or passengers. According to some embodiments, detachable capsules may, after detachment, be piloted by pilots or by automated systems (unmanned) or a combination of the two.

### FIELD OF THE INVENTION

The present invention generally relates to the field of Aircrafts. More specifically, the present invention relates to detachable pilotable capsules, including detachable flight data recorders (“black box”), and aircrafts including detachable pilotable capsules.

### BACKGROUND OF THE INVENTION

Though in the process of design and operation of civil aircraft severe measures are taken to ensure equipment reliability and safety, numerous aircraft malfunctions occur annually, leading to irrecoverable aircraft and human losses.

FIG. 1A presents statistics of incidents involving civil aircraft that occurred during the period 1959-2012. This data is provided according to “Statistical Summary of Commercial Jet Airplane Accidents Worldwide Operations 1959-2012”.

As can be seen in FIG. 2, most incidents resulting in irrecoverable aircraft and human losses occur due to a loss of aircraft control in the air (see LOC-I graph of FIG. 2), or because of an impossibility to perform a safe landing (e.g. due to failures of aircraft equipment or a lack of an appropriate landing area (see CFIT graph of FIG. 2).

In most cases human losses could be avoided through the timely evacuation of passengers and crew from the aircraft exposed to a risk of crash.

### PRIOR ART

Consider the patent RF 2425781, issued in the name of Bertani Romolo Lorenzo.

The patent RF 2425781 presents the following structure to be implemented: the fuselage that comprises the upper pilotable portion and the lower separable portion; which is in turn attached to the upper fuselage portion during the normal operation and can be detached in case of emergency. The upper wing is attached to the upper pilotable fuselage portion, the lower wing attached to the lower separable fuselage portion. A releasable engagement means intended to attach the lower separable fuselage portion to the upper pilotable portion with a possibility of detachment. These releasable engagement means can be activated during the flight to provide detachment of the lower separable portion from the upper pilotable fuselage portion. A design of the upper pilotable portion allows performance of controlled flight without the lower separable fuselage portion. The upper pilotable fuselage portion may have an additional cockpit with controls and equipment, which is separate from the main crew cockpit where pilots fly an aircraft till the detachment of the lower separable fuselage portion.

A detailed analysis of this patent (RF2425781) has identified several features of this structure that make it less cost-effective or decrease probability of the safe evacuation of passengers and crew in case of catastrophic or hazardous on-board events:

1—In practice, the patent RF2425781 offers to combine two fully-functional aircrafts; this solution significantly increases a weight of the structure with probability of different failures of separable portion equipment, similarly to any civil aircraft.
2—both portions are described to have an engine, fuel system and fully-functional control system (including necessary sources of hydraulic/pneumatic energy), as well as landing gear, thus increasing a weight of the separable portion, as well as the total aircraft.
3—The suggested solution still has probabilities of engine failures and fuel ignition during the emergency.
4—As this structure can only land in an appropriate airfield, similarly to conventional aircraft, fuel permanently stored in the upper separable portion must be sufficient to allow the aircraft to reach the airfield appropriate for the landing from any place where the upper portion has been separated from the lower one. These requirements increase a total weight of the aircraft.
5—The patent RF 2425781 suggests an arrangement of engines on two sides in the aft section of the aircraft, thereby limiting takeoff and landing to standard airplane takeoff and landing.
6—In addition to the main cockpit where pilots fly the aircraft prior to separation, upon detachment of the lower separable fuselage portion, the patent suggests another cockpit for the separable portion. This solution delays any separation of the aircraft during emergency, as time is required for the pilot to transfer from one cockpit to another and commence the separation. Such transfer may also not be physically possible, for instance, in cases of fire, failures resulting in a stall of the aircraft or positive or negative G-load and so on.
7. Due to the jet engine being on the upper separable portion, engine starting problems may occur in a case of an urgent separation of the upper pilotable portion, as follows:
a) Engine is surging at high speed at the moment of separation;
b) Stalling at high angles of attack;
c) a problem due to the engine starting method implemented:
C1) Cartridge starting is fastest, however it is a single-use mechanism;
C2) Starting from hydraulic/electric/pneumatic actuator: the main disadvantage is additional structure weight and complexity, as well as a relatively long period necessary for the engine to reach the operating mode—this delay can be critical in emergency situations;
C3) Windmill starting requires specific flight conditions and a significant amount of time;
d) Due to time limitations during such engine starts, a minimum altitude for separation will be relatively high.

In addition, to select optimal design solutions during development of this invention, the following patents have been analyzed: U.S. Pat. No. 6,682,017 BI, U.S. Pat. No. 3,881,671 A, WO 2001074659 A1, U.S. Pat. No. 2,684,219 A, RF No 2491207. These references suggest landing of a separable portion of an aircraft using parachute systems. This solution carries obvious faults. They are not effective in many conditions (e.g. bad weather or low altitude), they are complex to implement and carry an inherent failure risk, there is a need for significant space for the parachute systems and separation mechanisms and limit severely the amount of weight that can be landed. Further, with such systems the landing must be made at the point of separation—there is no option to improve the landing zone. This can be catastrophic (e.g. in a mountain range, in the arctic, etc).

Therefore, our invention shall provide solutions for the problems mentioned above and for a range of additional problems related to aircraft safety and cost-efficiency.

A common problem with these known solutions is that they are not suitable for large aircraft. Passenger aircraft continue to increase in size. The latest design by Airbus, the A380, having a wing span of approximately 80 m, is capable of carrying over 550 passengers on two separate decks. A further problem associated with aircraft, which have segmented passenger capsules, is that these systems require duplication of parachute systems and require sophisticated technology (e.g. rockets and/or lasers) capable of separating each capsule, as well as significant space for both parachute systems and separation mechanisms. This of course in turn leads to an increase in weight and manufacturing costs.

### SUMMARY OF THE INVENTION

The present invention includes capsules detachable from an aircraft and aircrafts including such capsules. According to some embodiments, there may be provided one or more capsules capable of flight and designed to detachably connect to an aircraft (hereinafter: “detachable capsules” or “pilotable capsules”). According to some embodiments, detachable capsules may be designed to carry cargo and/or passengers. According to some embodiments, detachable capsules may, after detachment, be piloted by pilots or by automated systems (unmanned) or a combination of the two.

This invention includes aircraft safety systems and methods designed to provide evacuation of passengers and crew in cases when a safe flight termination is improbable. Capabilities of this invention can also be used to compensate or minimize severities of effects of potential failure conditions and special events/risks, resulting in catastrophic and hazard effects to civil aircraft. The present invention further includes systems for rescuing valuable cargo from an aircraft in emergencies and systems for delivering/picking-up cargo/passengers from hard to reach places or in other situations in which it is undesirable to land the whole aircraft.

According to some embodiments there may be provided an aircraft structure comprising an aircraft with one or more pilotable passenger/cargo capsule(s) attached to the carrier during normal flight. Instead of the passenger capsules, payload capsules can be attached (unmanned options are also possible) to the carrier with the same arrangement. Capsules of different functionalities may be combined, thus enabling expansion of the scope of tasks they can perform.

A detachable pilotable portion (hereinafter referred to as a capsule or a module) may comprise a pilot cockpit, cargo hold and/or passenger cabin with all environmental control systems.

According to some embodiments, the detachable pilotable module may be equipped with one or more turbofan assemblies or fan assemblies (e.g. 4 assemblies). Combinations of turbofans and fans are also possible.

Turbofans may be actuated with gas generators, while fan assemblies may be actuated with accumulators.

According to some embodiments, the system may include releasable engagement means, intended to attach the pilotable capsule to the carrier with a possibility of detachment. According to further embodiments, after being detached, the carrier and the upper pilotable capsule may be adapted to reattach to the rest of the aircraft.

According to some embodiments, the releasable engagement means may be designed such that the pilotable capsule can be detached from the carrier (and/or attached to it) both in flight and on the ground.

All capsules may be designed to perform controlled flight without the carrier (i.e. without the rest of the aircraft).

Both passenger and payload capsule embodiments may have an aerodynamic configuration/exterior. According to some embodiments, pilotable capsules may be equipped with turbofan assemblies having independent gas generators. In cases of capsule separation, special doors (shutters or other similar structures) installed at turbofan outlets may provide thrust direction control, allowing flight control.

According to some embodiments, a detachable pilotable capsule including turbo-fans may separate from the aircraft, and may carry the cargo; transporting the cargo in the pilotable capsule, using the turbo-fans for controlled flight and landing of the pilotable capsule.

According to some embodiments, a method of transporting cargo from an aircraft in midflight may comprise:

detaching a pilotable capsule including turbo-fans from the aircraft, which pilotable capsule is carrying the cargo; and
transporting the cargo in the pilotable capsule, using the turbo-fans for controlled flight and landing of the pilotable capsule.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 presents a graph of accident rates and onboard fatalities by year, as published in “Statistical Summary of Commercial Jet Airplane Accidents Worldwide Operations 1959-2012”, Published by Boeing Commercial Airplanes, Aviation Safety, August 2013 at http://www.boeing.com/news/techissues/pdf/statsum.pdf;

FIG. 2 presents a graph of fatalities by CAST/ICAO common taxonomy team (CICTT) aviation occurrence categories, as published in “Statistical Summary of Commercial Jet Airplane Accidents Worldwide Operations 1959-2012”, Published by Boeing Commercial Airplanes, Aviation Safety, August 2013 at http://www.boeing.com/news/techissues/pdf/statsum.pdf;

FIG. 3 is an illustration of an exemplary aircraft including a detachable pilotable capsule and having a configuration with the detachable pilotable capsule located in the forward section, all according to some embodiments of the present invention;

FIGS. 4A-4E2 are illustrations of exemplary aircrafts including a detachable pilotable capsule and having a configuration with the detachable pilotable capsule located in the forward section, all according to some embodiments of the present invention, wherein:

FIG. 4A shows an exemplary pilotable capsule 402 disengaging from its carrier 401;

FIG. 4B shows the exemplary capsule and carrier immediately after separation (i.e. immediately following FIG. 4A);

FIG. 4C also shows the capsule and carrier shown in FIGS. 4A and 4B, immediately after separation (i.e. immediately following FIG. 4A). In FIG. 4C exemplary separate turbofan assemblies are shown; a central turbofan 410 and wing turbofans 411;

FIG. 4D is similar to FIG. 4C, however, this figure shows an embodiment having lift-cruise turbofans 412 on the wings of the capsule; and

FIGS. 4E1-4E2 illustrate further exemplary configurations of carrier and capsule;

FIG. 5 shows an exemplary lift turbofan, according to some embodiments of the present invention;

FIG. 6 shows an exemplary lift-cruise turbofan, according to some embodiments of the present invention;

FIGS. 7 & 7A present an exemplary military embodiment. As can be seen in FIG. 7, an unmanned carrier 701, having automatic control 721 is carrying 3 exemplary fighting units 720. FIG. 7A shows a more detailed view of the fighting units, which, as can be seen, are equipped with turbofans 723 for controlled flight;

FIG. 8 shows a block diagram of an exemplary charging system for a pilotable capsule power supply;

FIG. 9 is a structural diagram of an exemplary turbofan, including a cross section of the exemplary turbo fan (along the dotted line), presented above the structural diagram;

FIG. 10 shows exemplary embodiments of the present invention in which a passenger capsule 1002 is attached to the bottom of a carrier 1001;

FIG. 11 shows an exemplary embodiment of the present invention in which 2 passenger capsules 1102 are attached to the bottom of a carrier 1101;

FIGS. 12 & 12A show an exemplary embodiment of the present invention involving a disk-shaped configuration of aircraft with a hybrid power plant, wherein FIG. 12 shows the exemplary disk shaped aircraft with the carrier and pilotable capsule attached and FIG. 12A shows the exemplary disk shaped aircraft after separation of the pilotable capsule from the carrier;

FIG. 13 shows an exemplary pilotable capsule for evacuating/delivering sensitive cargo;

FIGS. 13A-13C present cross sections of the exemplary BBC shown in FIG. 13;

FIG. 14 shows another exemplary configuration of a BBC and a cross section of this exemplary configuration;

FIG. 15 shows another exemplary configuration of a BBC and a cross section of this exemplary configuration;

FIG. 16 shows yet another exemplary configuration of a BBC and cross sections of this exemplary configuration;

FIG. 17 shows an exemplary jettisoning of a BBC from a crashing aircraft;

FIG. 18 shows an exemplary supersonic configuration of the present invention and an interior view of this exemplary configuration;

FIGS. 19A-19B show exemplary detachable pilotable capsules having delta shaped wing structures;

FIGS. 20A-20C show exemplary detachable pilotable capsules having annular airfoils, wherein:

FIGS. 20A and 20B present an exemplary compound aircraft with annular (oval) airfoils both on the carrier and the capsule; and

FIG. 20C shows an exemplary compound aircraft with an annular airfoil on the carrier and a standard foil on the carrier;

FIGS. 21-25 show exemplary aircrafts including detachable pilotable capsules having 2 or more pairs of relatively small/short wings (or with inflatable or retractable wings), wherein:

FIG. 21 presents an exemplary aircraft including a detachable pilotable capsule having 2 pairs of short wings attached below an associated tail type carrier;

FIGS. 22 and 22A present an exemplary detachment process of the exemplary aircraft presented in FIG. 21, wherein

FIG. 22 presents the aircraft prior to detachment and FIG. 22A after detachment, all according to some embodiments of the present invention;

FIGS. 22B & 22C present an exemplary detachment process of an exemplary aircraft including a lower mounted detachable pilotable capsule, wherein FIG. 22B presents the aircraft prior to detachment and FIG. 22C after detachment, all according to some embodiments of the present invention;

FIG. 23 presents an exemplary aircraft including a detachable pilotable capsule having 2 pairs of short wings attached above an associated tail type carrier;

FIG. 24 presents an exemplary aircraft including a detachable pilotable capsule having 2 pairs of short wings attached below an associated annular foil tail type carrier;

FIG. 24A presents an exemplary carrier portion of the exemplary aircraft presented in FIG. 24, according to some embodiments of the present invention;

FIG. 24B presents an exemplary detachable pilotable capsule portion of the exemplary aircraft presented in FIG. 24, according to some embodiments of the present invention;

FIG. 25A presents an exemplary rocket style aircraft including a detachable pilotable capsule;

FIG. 25B presents an exemplary detachment process of the exemplary aircraft presented in FIG. 25A;

FIGS. 26A-26B show exemplary detachable pilotable capsules for rotor based aircrafts, wherein FIG. 26A shows a small version and FIG. 26B shows a larger version;

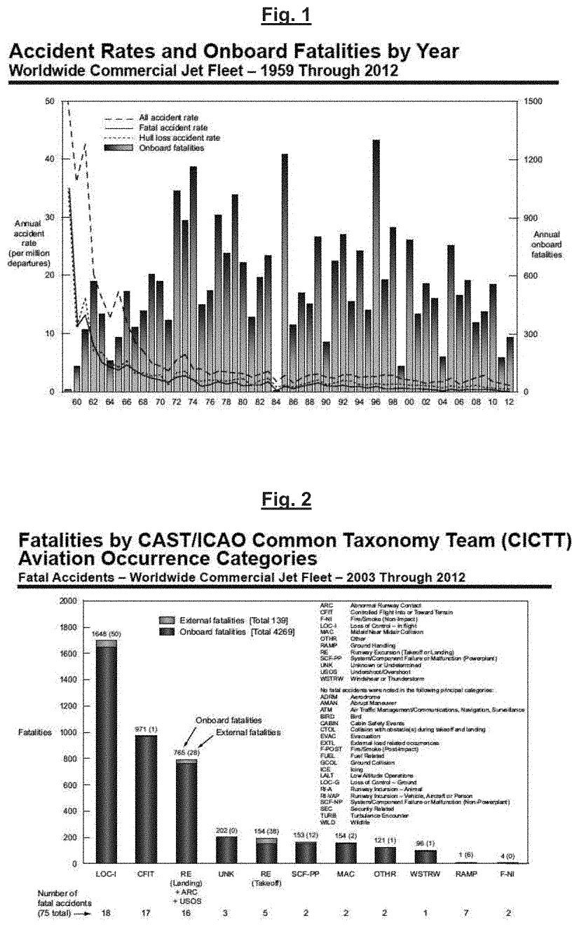

It will be appreciated that for simplicity and clarity of illustration, elements shown in the figures have not necessarily been drawn to scale. For example, the dimensions of some of the elements may be exaggerated relative to other elements for clarity.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The present invention includes pilotable capsules, detachable from an aircraft and aircrafts including such capsules. According to some embodiments, there may be provided one or more capsules capable of flight and designed to detachably connect to an aircraft (hereinafter: “detachable capsules” or “pilotable capsules”). According to some embodiments, detachable capsules may be designed to carry cargo and/or passengers. According to some embodiments, detachable capsules may, after detachment, be piloted by pilots or by automated systems (unmanned) or a combination of the two.

This invention includes aircraft safety systems and methods designed to provide evacuation of passengers and crew in cases when a safe flight termination is improbable. Capabilities of this invention can also be used to compensate or minimize severities of effects of potential failure conditions and special events/risks, resulting in catastrophic and hazard effects to civil aircraft. The present invention further includes systems for rescuing valuable cargo from an aircraft in emergencies and systems for delivering/picking-up cargo/passengers from hard to reach places or in other situations in which it is undesirable to land the whole aircraft.

According to some embodiments there may be provided an aircraft structure comprising an aircraft with one or more pilotable passenger/cargo capsule(s) attached to the carrier during normal flight. Instead of the passenger capsules, payload capsules can be attached (unmanned options are also possible) to the carrier with the same arrangement. Capsules of different functionalities may be combined, thus enabling expansion of the scope of tasks they can perform.

A detachable pilotable portion (hereinafter referred to as a capsule or a module) may comprise a pilot cockpit, cargo hold and/or passenger cabin with all environmental control systems.

According to some embodiments, the detachable pilotable module may be equipped with one or more turbofan assemblies or fan assemblies (e.g. 4 assemblies). Combinations of turbofans and fans are also possible.

Turbofans may be actuated with gas generators, while fan assemblies may be actuated with accumulators.

According to some embodiments, the system may include releasable engagement means, intended to attach the pilotable capsule to the carrier with a possibility of detachment. According to further embodiments, after being detached, the carrier and the upper pilotable capsule may be adapted to reattach to the rest of the aircraft.

According to some embodiments, the releasable engagement means may be designed such that the pilotable capsule can be detached from the carrier (and/or attached to it) both in flight and on the ground.

All capsules may be designed to perform controlled flight without the carrier (i.e. without the rest of the aircraft).

Both passenger and payload capsule embodiments may have an aerodynamic configuration/exterior. According to some embodiments, pilotable capsules may be equipped with turbofan assemblies having independent gas generators. In cases of capsule separation, special doors (shutters or other similar structures) installed at turbofan outlets may provide thrust direction control, allowing flight control.

Pilotable capsules may include the crew cockpit, where standard system control may be performed, according to some embodiments, and all necessary means to ensure safe flight in manned or automatic modes. In payload capsules that do not require the crew cockpit, an unmanned vehicle control system, possibly including a GPS device may be sufficient.

According to some embodiments, the carrier (rest of the aircraft) may have independent flight capabilities after being separated from capsules. Accordingly, the carrier may consist of a fuselage, wings where fuel tanks can be installed, engines, landing gear, tail, additional fuel tanks or other equipment and/or flight control systems.

According to some embodiments, the carrier may also include an automatic flight control system (with the necessary interface), designed to direct the carrier to the desired place of safe landing, maintain a holding pattern or reconnect to a detached capsule.

Gas generators may be installed in wings of detachable capsules.

According to some embodiments, Capsules may have control means as well as control and measuring equipment designed to allow manned piloting of the capsule before and after it's separation.

The releasable engagement means may include an array of releasable engagement mechanisms. For example, each releasable engagement mechanism may include a detachably engageable jaw or clamping assembly. Any connection known today or to be devised in the future may serve as releasable engagement mechanisms, according to some embodiments of the present invention. Further, combinations of different types of engagement/attachment mechanisms may be employed.

According to some embodiments, to attach capsules to the carrier, various types of pyrobolts, disconnect interconnectors or sliding guides may be used. Reusable interconnectors may also be used to provide reattachment (docking) of the detachable capsule to the carrier.

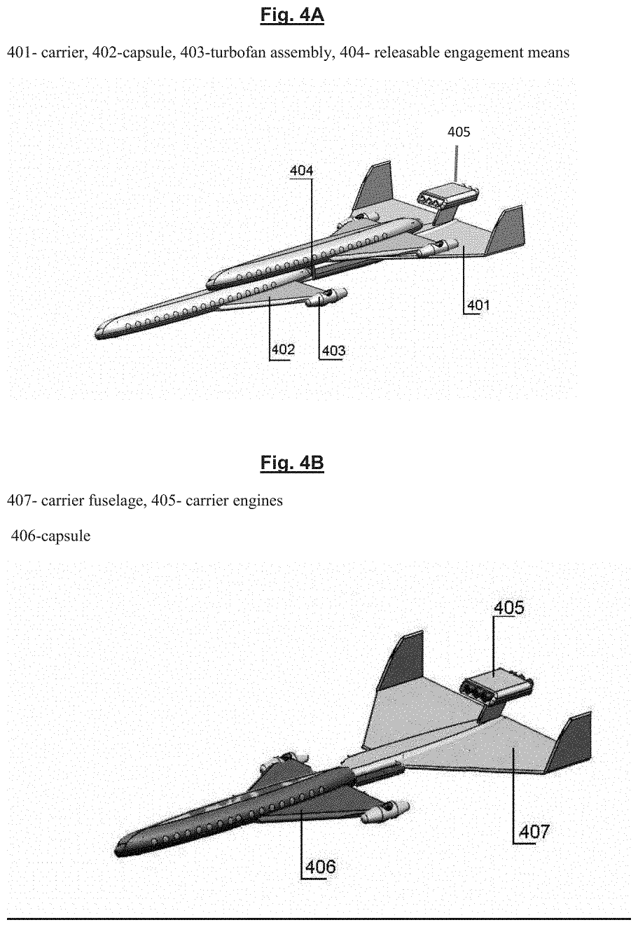

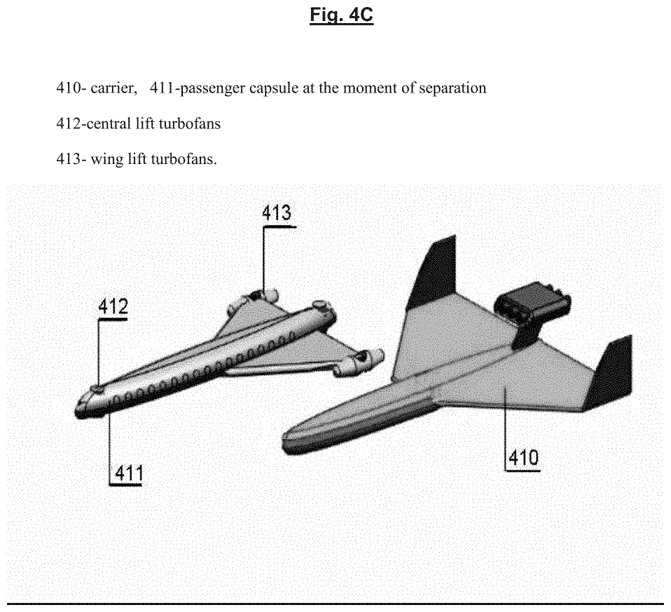

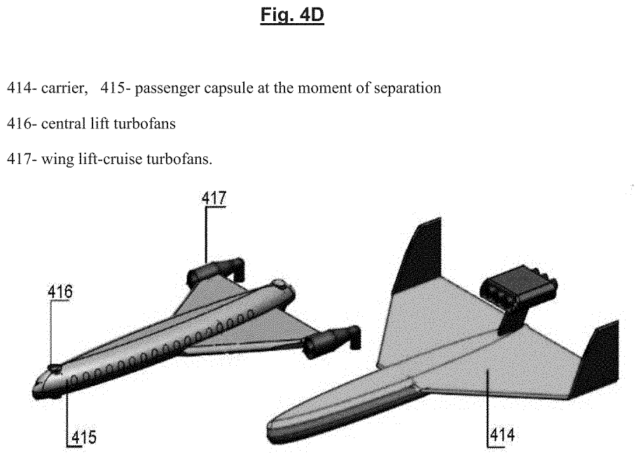

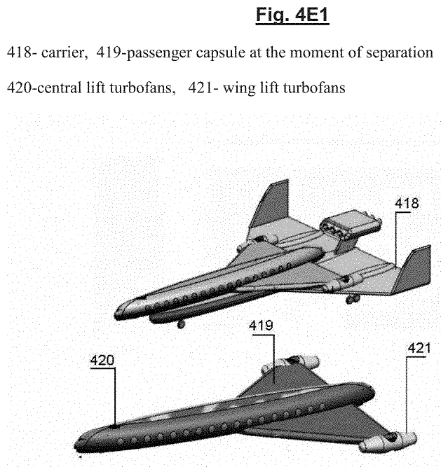

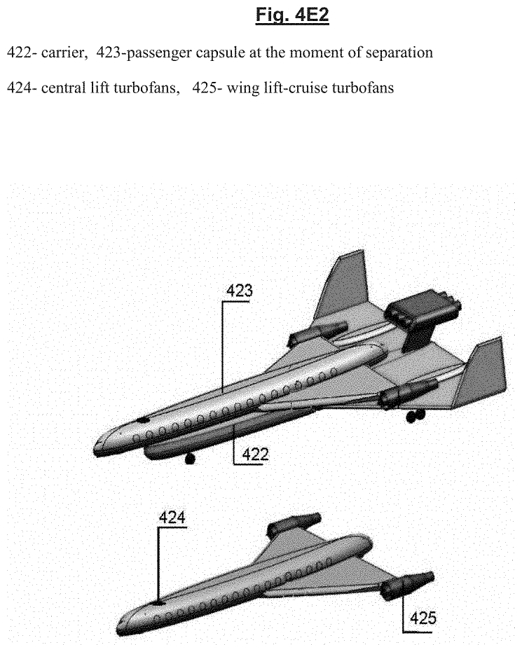

According to some embodiments, capsules may be arranged on the upper part of the carrier with some clearance (see FIG. 4F1 for example) to create a zone of low pressure. This low pressure zone can help to provide an additional force attaching a pilotable capsule to a carrier. Due to the configuration of upper capsule attachment, the turbofans also can be used for creating additional thrust during the flight.

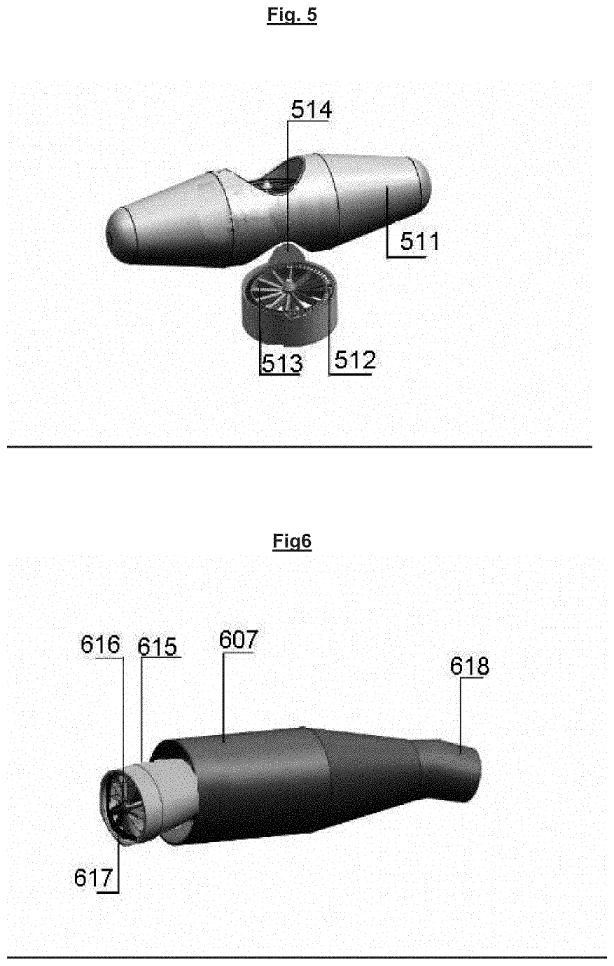

According to some embodiments, after being separated, a capsule may be able to move in any direction using the turbofans. This invention may use both lift turbofans (FIG. 4) and lift-cruise turbofans (FIG. 5).

According to some embodiments, when separation is desired, valves of gas generators may drop open by command of the crew, or automatically. Gas may thus be supplied to turbines, enabling fast rotation of the fan, which blows air, thus producing a thrust load. Using the thrust load, the capsule may detach from the carrier, performing controllable flight till landing. A process of landing may be similar to this performed by vertical take-off aircrafts, such that landing deceleration is low and safe.

In case of programmable separation or a cargo drop, the process may be similar. This invention suggests a new approach to civil aircraft safety tasks as well as to delivery of cargo to remote areas.

According to some embodiments, a pilotable capsule may include an additional autopilot system (e.g. an Emergency Autopilot system). The additional Autopilot system may be comprised of separate hardware and software from the regular aircraft autopilot. The additional autopilot system may be designed to compensate for side moments (roll and yaw) and angle of attack while separating from the carrier, as well as computing safe landing trajectories of the pilotable capsule. According to further embodiments, the autopilot functions may be expanded to include automatic landing capabilities. The additional autopilot system may also be used as a redundant system during the flight of the carrier. According to further embodiments, in order to provide additional reliability, it is proposed to implement constant built in tests (high level CBIT) of the autopilot in order to check its integrity. It is further proposed to implement warning signals in cases of autopilot failure. In a case of an Autopilot failure, separation may be carried out by the primary autopilot or manually. An additional autopilot system allows performing a pilotable capsule separation in cases of primary autopilot failure. Additionally, during regular flight, the additional autopilot system can be used as a reference system for the primary autopilot, which increases the overall reliability of the autopilot system.

According to some embodiments, additional airspeed sensors (possibly including heating components) and inertia sensors may be installed in a pilotable capsule in order to control the capsule after its disengagement. These sensors can also be used as backups and/or reference for the carrier sensor systems.

According to some embodiments, a pilotable capsule may include an automatic system for evaluating current flight conditions and current capsule equipment condition to determine at each given moment if separation is currently possible and safe. Such functions may be embodied in the above mentioned additional autopilot channel. Evaluations may be constant, periodic or in response to particular events or situations/conditions. Further, the evaluation system may output results of its evaluations to the pilots and/or any other relevant party.

During separation of a pilotable capsule from a carrier, the carrier engines and flight controls may be used in order to stabilize the aircraft longitudinally and laterally, manually and/or automatically/semi-automatically in order to facilitate easier/safer/more-efficient separation (the closer to horizontal flight the better). If aircraft stabilization by carrier systems is impossible or difficult (e.g. due to the nature of the failure that has led to the separation to begin with) capsule flight systems can be used to stabilize the carrier and/or detachable module prior to separation (e.g. turbo fans may be used for stabilization).

According to some embodiments, an aircraft including a pilotable capsule may include an automatic separation mechanism in certain emergency situations (e.g. when the emergency is such that there is insufficient time for pilot action, when the pilot is the problem and so on).

Features and advantages of some particular embodiments of this invention:

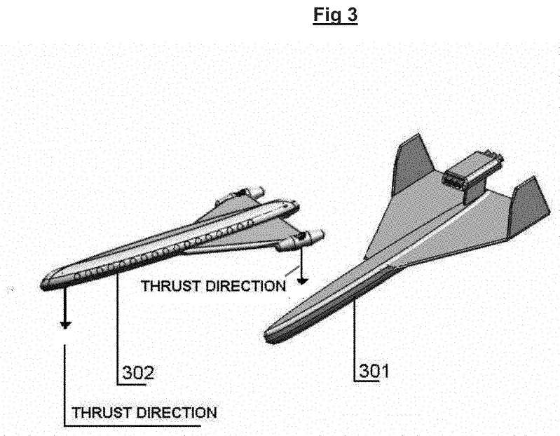

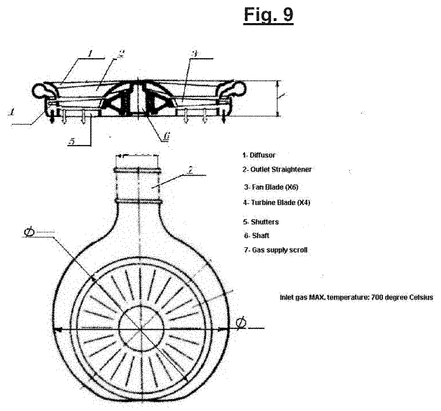

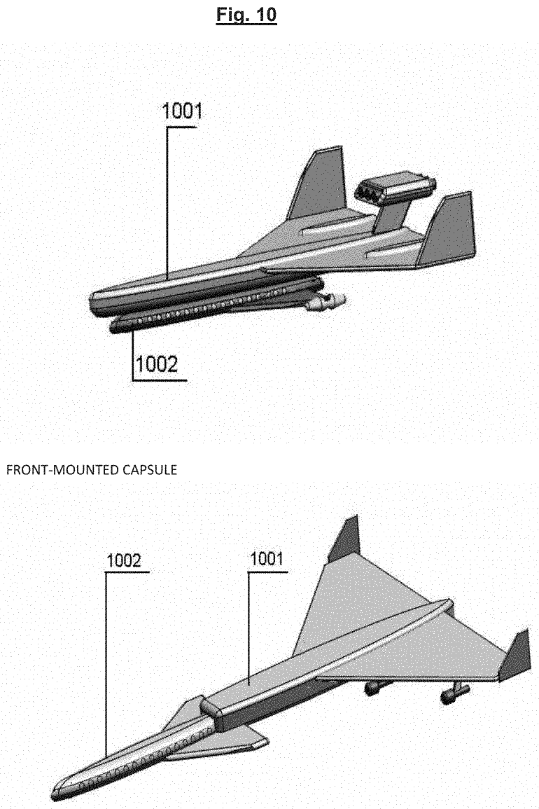

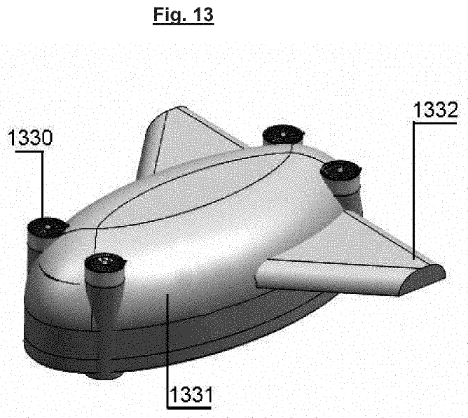

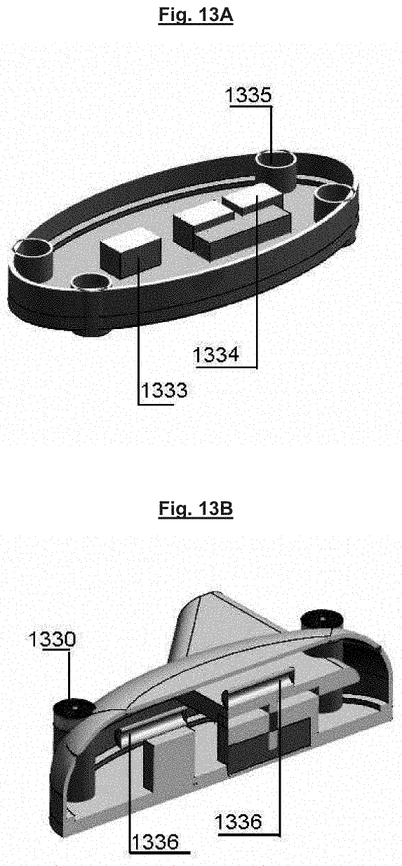

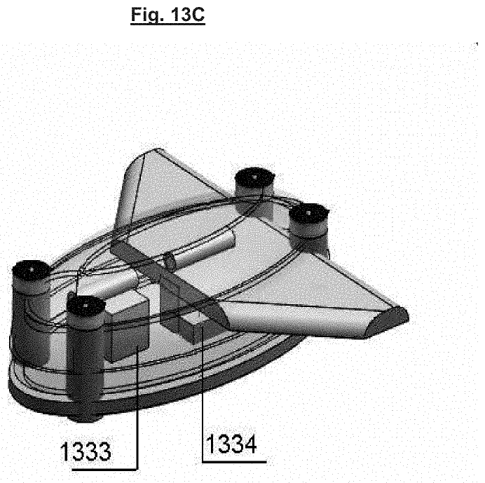

1) A design of the detachable pilotable capsule may be relatively simple such that hydraulic and pneumatic systems may be minimized. As a result, a weight of this structure may be decreased, while its reliability is increased.
2) The detachable pilotable capsule may perform controlled landing with low vertical speed on any appropriate area or on the water, obviating the need for a specially equipped airfield.
3) The detachable pilotable capsule may not contain jet engines nor landing gears, nor integrated control systems with all their associated equipment, thus reducing weight of the landing structure. Besides, it should be noted that due to an exclusion of systems mentioned above from this structure, it may be less prone to failures, since failures of these systems reduce total aircraft reliability rates. For example, the landing gear is the only aircraft system, whose single failure can result in hazard effects (landing with no gear extended or landing with gear partially extended).
4) The suggested structure allows the pilotable capsule to be detached in any direction and with various angles of attack, and not only forward as in the patent RF 2425781. The turbofans provide module stability at different angular moments in cases of emergency detachment, also providing lateral stabilization of the capsule.
5) If necessary, the detachable pilotable capsule may be able to perform controlled flight for significant distances, providing transportation of passengers and crew and/or cargo. According to some embodiments, a pilotable capsule may be equipped with special equipment to provide evacuation from the air, e.g. of injured people on roofs of hospitals etc.
6) The configuration with the detachable pilotable capsule located in the forward section (see Error! Reference source not found.) allows the use of a nuclear engine as an energy source for the whole aircraft. Such a configuration (see Error! Reference source not found.) also provides an inherent protection of the passenger nacelle against a hit of infra-red guided missiles, as the engines (which are the missile's targets) are installed in the tail section, at a considerable distance from the passenger capsule. Such configurations ensure protection against radar guided missiles, because the effective reflex surface of the carrier is larger than that of the capsule.
7) According to some embodiments, the carrier (mother module) may be equipped with its own autonomic navigation system, autopilot and/or other equipment which provides a possibility to perform the following functions:
a) To withdraw the detached carrier (mother module) far away from people and civilian buildings.
b) In cases when it isn't possible to safely land the detachable carrier, or if the safe landing is uncertain, it is proposed to perform an emergency fuel disposal from the detachable carrier. This solution can decrease the effect caused by collision of the carrier (mother module) with ground objects. Another possible solution is to perform an initiated destruction of the carrier in the air, before its approach to the ground objects.
   8) According to some embodiments, the capsules and carriers described herein may include an automatic function which performs an automatic docking of the pilotable capsule with the carrier (mother module). The automatic docking function may be performed when the carrier is in automatic flight, or when the carrier is on the ground. This function may assist with some or all of the following tasks:
a) To allow passengers or cargo to board an aircraft while the aircraft remains in the air, without a specially equipped airfield or in cases of extra-cost service;
b) The evacuation of people from an area where landing the aircraft is dangerous or impossible. In such cases, the carrier can automatically fly close to the evacuation zone and provide the possibility of the automatic docking with the pilotable capsule. Alternatively, the carrier may be flown by pilots while the capsule retrieves the passengers and/or cargo from the area (either by automatic flight or by other pilots).
   9) According to some embodiments, an aircraft with two or more pilotable capsules may be provided. Two or more pilotable capsules may be similar (multiple capsules of the same kind) or distinct (multiple different types of capsules—e.g. one for cargo and one for passengers.)
   10) According to some embodiments, an aircraft having detachable pilotable capsules may be used for dropping off and picking up passengers/cargo without landing of the whole aircraft. A new pilotable capsule (or the same one after exchanging cargo) with new passengers or cargo may dock onto the aircraft. Potentially, the new pilotable capsule may carry fuel tanks with fuel and other interfaces required for aircraft refueling and may perform refueling of the aircraft after docking. In this manner, an aircraft may drop off and pick up cargo/passengers at many stops without landing at each one—thereby reducing the infrastructure needed at each stop and possibly saving time of take off and landing.
   11) According to some embodiments, a separation of a capsule may be performed when the aircraft is on the ground. For instance, an immediate evacuation of an aircraft may be required due to fire of engines/fuselage. Therefore, an evacuation of passengers and crew through the detachable capsule may be faster and/or safer than the standard evacuation through emergency exits.
   12) As an option, a concept of compound aircraft systems allows to create brand new systems that in the long view are intended for forest fire fighting, people rescuing from high-rise buildings as well as performing search and rescue operations.
   13) An advantage of turbofans is environmental compatibility of the process, since it supplies an air stream, and not a gas.
   14) Capabilities of turbofans can be used to evacuate flight recorders (see FIGS. 13-16), thus allowing the further investigation of crash causes.
   15) This invention allows detachment of the capsule from the carrier in difficult flight situations, while the level attitude is maintained both at the stall mode and pitch down mode. This is a result of the use of controlled turbofans and stabilization system that provide an advantage in comparison with existing solutions.
   A scheme of detachment of the capsule at the stall/pitch down mode is presented in FIG. 3.
   16) Fans installed in the detachable controllable module may be used as an alternative source of electrical energy (see FIG. 8), in case of complete loss or partial loss of electric power system, possibly allowing for the exclusion of RAM and APU from AC design;
   17) Fans installed in a detachable capsule may be used to perform air bleeding functions for the carrier systems, possibly providing normal operation of integrated air management systems in cases of failure of air bleeding from main engines or in cases of toxic substances appearing in air bled from engines;
   18) Flight controllers of the detachable capsule ensure redundancy of avionics complex during normal flight, thus providing aircraft avionics reliability growth;
   19) In embodiments where a detachable capsule is attached atop a carrier (e.g. FIGS. 4A-4F) protection of the passenger cabin against effects of landing with landing gear retracted or aircraft overrun can be achieved. Due to controllability of position of the detachable module relative to the carrier, an additional aircraft deceleration can be provided as a result of lifting a forward section of the capsule, in case of loss of braking system or forced landing on a short-runway airport.
   20) Fans with electric engine of a pilotable capsule may be used to provide additional reverse thrust for the carrier;
   21) In embodiments where a detachable capsule is attached in the forward section of a carrier (e.g. FIG. 10) protection of the passenger cabin against cases of main engine destruction followed by fragment disbursement;
   22) Due to a redundancy of some aircraft systems in the capsule, a number of common mode failure effects on aircraft systems can be significantly decreased, while tolerance to special risks is increased;
   23) A thrust produced by turbofans of a pilotable capsule may be applied in cases of loss of a single engine of the carrier during a climb with landing gear extended, or for short runway take-off, or in case of runway failures or conditions when an aircraft is decelerated after reaching V1. Consequently, it can provide correction for these failures that do not allow the aircraft to gain speed required for lift up or maintain the necessary climb gradient. In other words, the thrust of the capsule turbofans can be used to augment the thrust of the carrier engines;
   24) Lift/thrust produced by capsule fans can also be applied during difficult landings.
   25) Lift/thrust produced by capsule fans can also be applied during takeoff, which may in turn allow modification/improvement of aircraft design parameters.

Other applications of detachable pilotable capsules may include:

### 1—Rescue Operations

In this case the carrier may transport the capsule to the relevant area and then the detachment of the capsule may be performed. As the capsule may have vertical landing capabilities, it may perform a smooth descent, take people that need to be rescued and then perform a vertical ascent back to the carrier. This modification of the capsule may be equipped with its own engine to ensure proper operation of the turbofans. After lift-off, the capsule may return to the carrier or perform an independent flight to the nearest safe zone. Such rescue operations may be performed in such areas as mountains and canyons where standard helicopters cannot perform the landing due to their big rotors.

### 2—Launching of Compound Spacecraft

The carrier may transport the capsule with the space vehicle to the predetermined launching area, where the capsule with the space vehicle onboard may be detached from the carrier. The carrier may then depart the launching area, leaving the capsule to perform the launching of the space vehicle. An advantage of this method is an increase of launching accuracy and operating time for decision making to correct the launch, as the capsule can hover at the same height and location. After launching, the capsule may return to the carrier or may land independently. 3—Military Use
An application of this compound scheme for unmanned flying vehicles allows to extend their possibilities. With a single carrier and several detachable capsules, a range of missions can be expanded, while a cost can be decreased. The capsules may be used for delivery (cargo and/or personnel) and/or for rescue/extraction of cargo and/or personnel. Capsules may also be used as tactical weapons and/or for surveillance tasks.

### 4—Diversion Target for Air Defense Systems

Since the capsule can hover at a given height and move with low speed, it may be perceived by air defense systems as a real target.

### Exemplary Calculations of Turbofan Based Pilotable Capsules

As an exemplary calculation of Turbofan based pilotable capsule basic technical parameters let us look to the following:
an exemplary turbofan thrust may be 10,000 kg
a diameter of such a turbofan may be 2 m
weight may be 300 kg
   The passenger capsule may, for example, have 4 turbofans installed.
   Their overall thrust is thereby 40,000 kg.
   Considering the standard thrust-to-weight ratio in avionics is m=1.2, the maximum weight of the passenger capsule might therefore be 33,000 kg.
   An approximation of the specific weight of the capsule structure per single passenger may be 300 kg, thus allowing accommodation of 110 passengers in the capsule, in the above exemplary configuration.

Obviously, modification of the above exemplary configuration may allow for more or less passengers/cargo. For example, according to further embodiments, installation of additional turbofans (or more powerful turbofans) may increase passenger/payload capacity.

### Exemplary Embodiments

It will be appreciated that for simplicity and clarity of illustration, elements shown in the figures have not necessarily been drawn to scale. For example, the dimensions of some of the elements may be exaggerated relative to other elements for clarity.

It should be understood that the accompanying drawings are presented solely to elucidate the following detailed description, are therefore, exemplary in nature and do not include all the possible permutations of the present invention.

The following is a description of some specific exemplary implementations of the present invention. These following specific exemplary embodiments of the present invention are presented to further clarify the present invention and the possible implementations of its principles, and as such, should not be understood to encompass the full scope of the present invention in any way. It should be clear to anyone of ordinary skill in the art that many other implementations of the present invention are possible.

FIG. 4A shows an exemplary pilotable capsule 402 disengaging from its carrier 401. As can be seen in the Figure, during regular flight the capsule resides atop the carrier and detaches forward upon detachment. The turbofans 403 of the capsule can also be seen, as can the jet engines 405 of the carrier 401. In this example the capsule is resides within a slot on the carrier, such that the only attachment mechanism 404 necessary is in the front of the carrier. As can be seen, the capsule has its own wing structure 406, separate from the carrier wing structure 407.

FIG. 4B shows the exemplary capsule and carrier immediately after separation (i.e. immediately following FIG. 4A). In FIG. 4B the arrow markings show that the capsule can change its angle at the moment of separation from the carrier. For example, if during the emergency detachment process, the aircraft cannot compensate the roll moments, the pilots can use the capsule turbofans for rotation of the capsule to the horizontal position during, or immediately after, the separation from aircraft.

FIG. 4C also shows the capsule and carrier immediately after separation (i.e. immediately following FIG. 4A). In FIG. 4C exemplary separate turbofan assemblies are shown; a central turbofan 410 and wing turbofans 411, all according to some embodiments of the present invention.

FIG. 4D is similar to FIG. 4C, however, this figure shows an embodiment having lift-cruise turbofans 412 on the wings of the capsule, according to some embodiments of the present invention.

FIGS. 4E1-4E2 illustrate further exemplary configurations of carrier and capsule:

In FIG. 4E1 there is shown: a carrier 418, a passenger capsule at the moment of separation 419 central lift turbofans 420 and wing lift turbofans 421. In FIG. 4E2 there is shown: a carrier 422, a passenger capsule at the moment of separation 423 central lift turbofans 424 and wing lift-cruise turbofans 425.

FIG. 5 shows an exemplary lift turbofan, according to some embodiments of the present invention. In the figure the Turbofan Nacelle 511 can be seen. The turbine 512, fan 513 and duct supplying gas from the gas generator 514 can also be seen.

FIG. 6 shows an exemplary lift-cruise turbofan, according to some embodiments of the present invention. In the figure the Turbofan Nacelle 607 can be seen. The turbofan housing 615, turbine 617, fan 616 and vectoring nozzle 618 can also be seen.

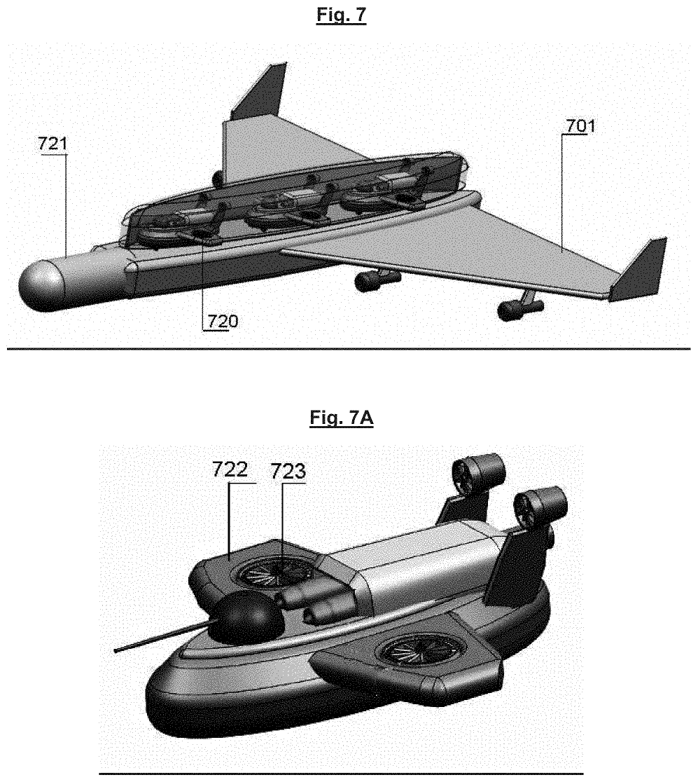

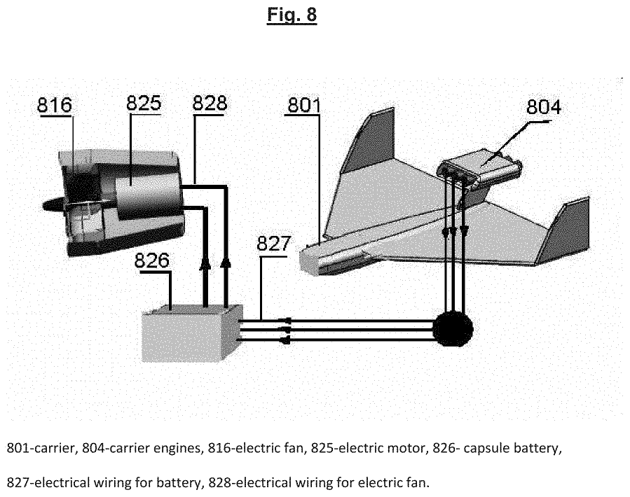

FIGS. 7 & 7A present an exemplary military embodiment. As can be seen in FIG. 7, an unmanned carrier 701, having automatic control 721 is carrying 3 exemplary fighting units 720. FIG. 7A shows a more detailed view of the fighting units, which, as can be seen, are equipped with turbofans 723 for controlled flight.

FIG. 8 shows a block diagram of an exemplary charging system for a pilotable capsule power supply. As can be seen, according to some embodiments, a carrier's engines may be utilized to charge a pilotable capsule power supply during flight. According to some further embodiments, turbo-fans of a pilotable capsule thus charged by an engine of a carrier aircraft may be used to provide additional/directional thrust for the aircraft during flight while the capsule is still connected to the carrier, or the described electric system may also serve as a redundancy for the aircraft electric system, or portions thereof (e.g. as a redundancy for the emergency electric system).

FIG. 9 is a structural diagram of an exemplary turbofan.

FIG. 10 shows exemplary embodiments of the present invention in which a passenger capsule 1002 is attached to the bottom of a carrier 1001.

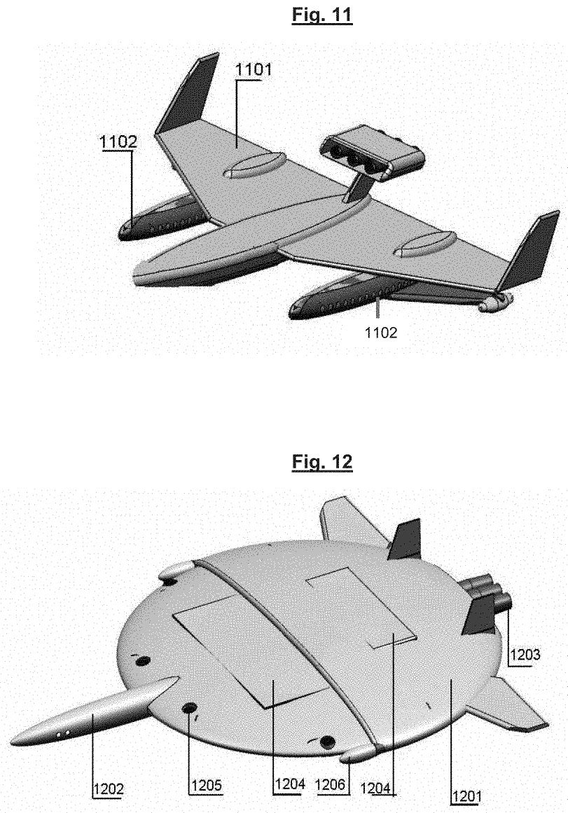

FIG. 11 shows an exemplary embodiment of the present invention in which 2 passenger capsules 1102 are attached to the bottom of a carrier 1101.

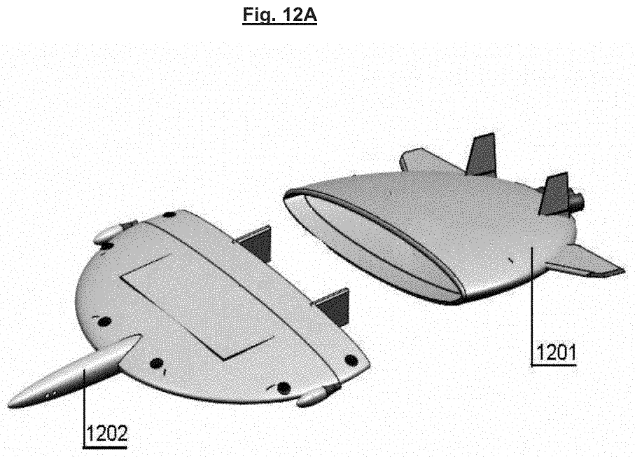

FIG. 12 shows an exemplary embodiment of the present invention involving a disk-shaped configuration of aircraft with a hybrid power plant. In the figure the carrier is marked 1201, the pilotable capsule 1202, the carrier engines 1203, exemplary solar panels and power generators 1204, lift turbofans 1205 and lift-cruise turbofans 1206. FIG. 12A shows an exemplary separation of the capsule from carrier of the aircraft embodiment shown in FIG. 12.

FIG. 13 shows an exemplary pilotable capsule for evacuating/delivering sensitive cargo (e.g. a black box, hazardous chemicals, nuclear materials, sensitive data, diamonds, etc.) from an aircraft (hereinafter: the “Black Box Capsule” or “BBC”). As can be seen, a BBC may comprise a Housing 1331, turbofans 1330 and a wing structure 1332, which may be an inflatable wing structure.

FIGS. 13A-13C present cross sections of the exemplary BBC shown in FIG. 13. As can be seen, within this exemplary BBC there may be one or more data storages (or other sensitive cargo) 1333 and 1334, channels and housing for the turbofans 1335 and compressed air/gas canisters/containers for turbofan operation 1336, as well as ancillary components for its operation (e.g. flight controllers, mechanical actuators, electric power supply, communication/transmission circuitry and relevant equipment, inflatable components for floatation, a GPS device, a parachute for failure conditions, etc.).

FIG. 14 shows another exemplary BBC. As can be seen, this exemplary BBC may also comprise a Housing 1401 and turbofans 1402. As can be seen, within this exemplary BBC there may be one or more data storages (or other sensitive cargo) 1406 and 1407, compressed air/gas canisters/containers and/or accumulators for turbofan operation 1405, as well as ancillary components for its operation (e.g. flight controllers 1404, mechanical actuators, electric power supply, communication/transmission circuitry and relevant equipment 1403, inflatable/rubber components for floatation 1408, a GPS device, a parachute for failure conditions, etc).

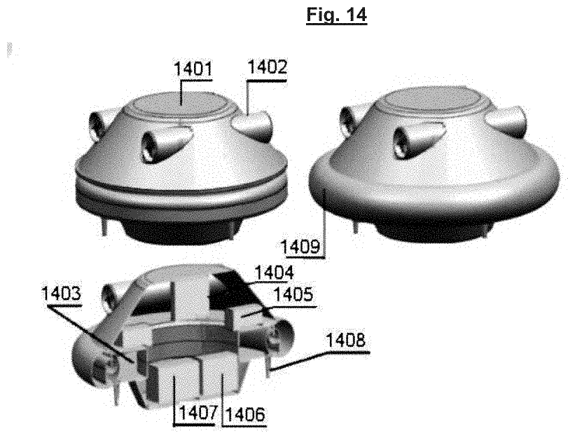

FIG. 15 shows a third example of an exemplary BBC. As can be seen, this exemplary BBC may also comprise a Housing 1501 and turbofans 1506. As can be seen, within this exemplary BBC there may be one or more data storages (or other sensitive cargo) 1503 and 1504, compressed air/gas canisters/containers and/or accumulators for turbofan operation 1405, as well as ancillary components for its operation (e.g. flight controllers 1509, mechanical actuators, electric power supply, communication/transmission circuitry and relevant equipment, inflatable/rubber components for floatation, a GPS device, a parachute for failure conditions, etc).

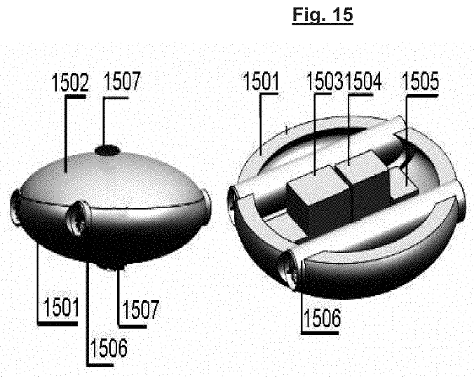

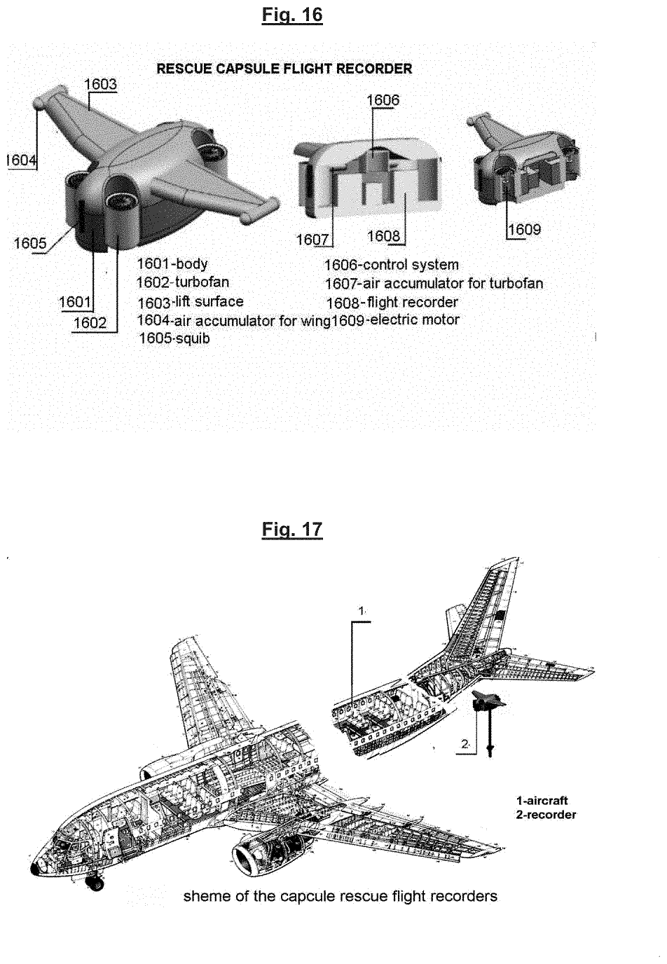

FIG. 16 shows yet another example of an exemplary BBC. This exemplary BBC, during regular flight may reside, possibly with folded wings, in the aft section of the aircraft. In case of a catastrophic or hazardous situation the capsule may be jettisoned down using squibs. Once jettisoned, the lift surface of the capsule may be inflated using the air accumulators for the wings. The air accumulators for turbofans may also be activated, such that the capsule is stabilized through turbofan rotation. The capsule flight may be controlled by the inner control system. The turbofans may be equipped with electric motors that can be engaged if the turbofan fails. Power for the electric engines may be provided by the electric accumulator, which may be charged during the regular flight. This scheme of capsule rescue allows a smooth descent of the cargo, thereby maintaining its integrity. Aside from this, this scheme saves significant resources during the search for the capsule, since the capsule can be landed on any surface, including water. The inflatable lift surfaces of the capsule may provide for flotation of the capsule once it has landed on a body of water.

FIG. 17 shows an exemplary jettisoning of a BBC from a crashing aircraft.

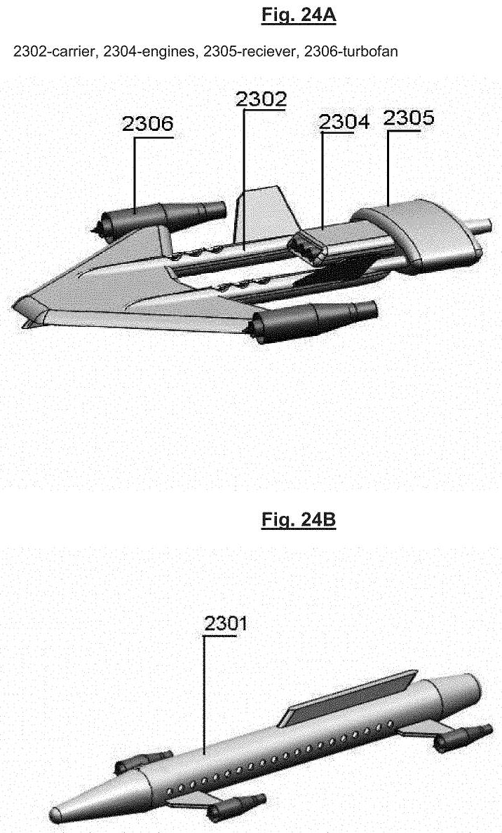

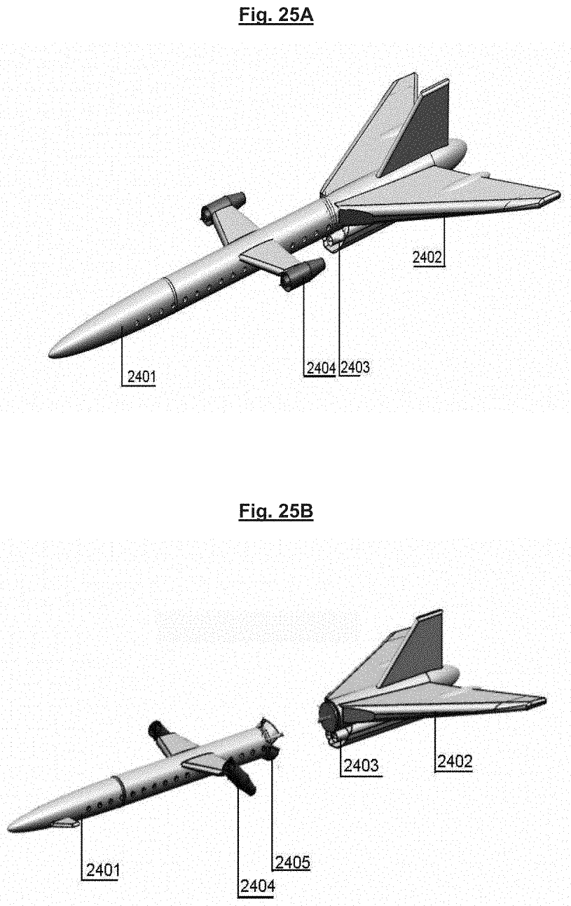

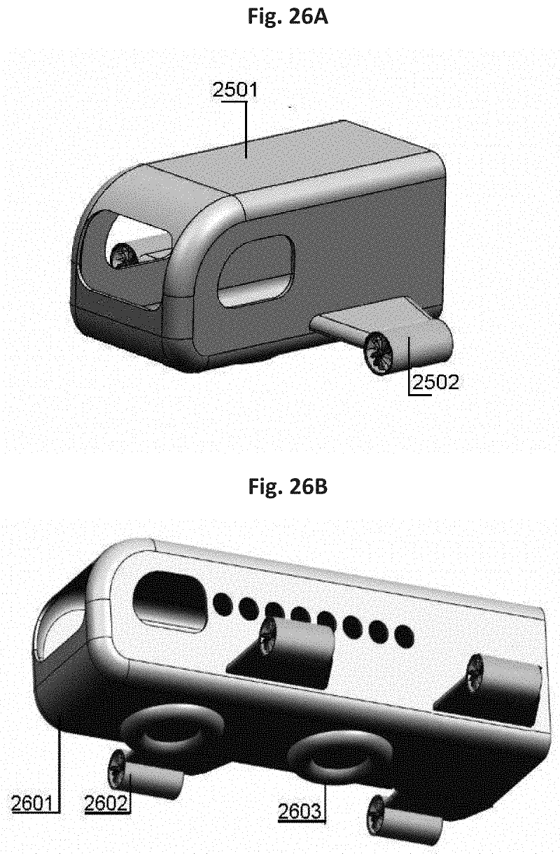

According to some embodiments of the present invention a rescue system for rotor aircrafts (e.g. helicopters, convertiplane) using the principles of the present invention may be provided (see FIGS. 25-26). According to such embodiments Helicopters (or other rotor aircrafts) may be equipped with symmetrically located turbofans. Depending on a structure of the helicopter, they may be located both in its forward and aft sections, as can be seen in FIG. 26. A design of the helicopter may provide for the detachment of a pilotable capsule, carrying crew and/or passengers, from the fuselage, rotor and/or tail in emergency situations. In FIGS. 25-26, turbo fans are marked 2502 or 2602, pilotable capsules 2503 or 2603 and specialized landing gear 2603.

After detachment the turbofans may be activated; their exhaust nozzles may be rotated from 0 to 90 degrees. The air flow from the nozzle produces a lift (thrust) that allows a smooth descent of the capsule. In addition, according to yet further embodiments, an emergency landing may be performed on water using inflatable/floatation components (e.g. flexible containers located under the capsule, inflatable sides, etc.).

A rotor aircraft with a detachable capsule may be equipped with any system that allows a fast jettison of the rotors, if no automatic detachment has occurred. Since the turbofans make the rotor aircraft heavier, it may be compensated by installing an electric motor on the same shaft with one or more of the turbofans. During normal flight the electric motor may rotate the turbofan, producing an additional thrust to compensate for the extra weight.

According to further embodiments, detachable pilotable capsules as described herein may be attached to an adapted convertiplane V-22 OSPREY (multi-mission, military, tilt rotor aircraft with both a vertical takeoff and landing, and short takeoff and landing capability). An example of such an embodiment is shown in FIG. 11. As can be seen in the Figure, two pilotable capsules 1102 may be attached to one carrier 1101.

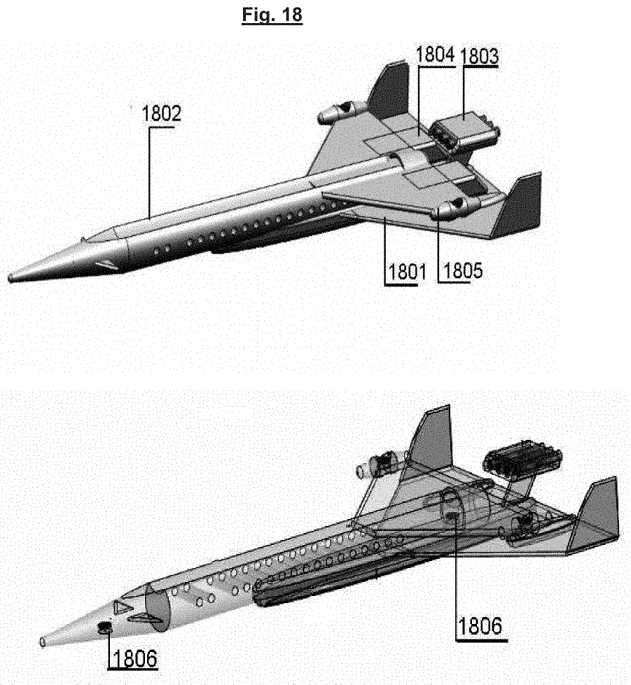

FIG. 18 shows an exemplary supersonic configuration of the present invention. As can be seen, an exemplary supersonic configuration may comprise: a carrier 1801, a pilotable capsule 1802, dual-flow turbojet engines 1803, straight turbojet engines 1804, wing turbofans 1805, integral turbofans 1806. The exemplary supersonic configuration allows detachment of the capsule at very high speeds, including mach plus speed.

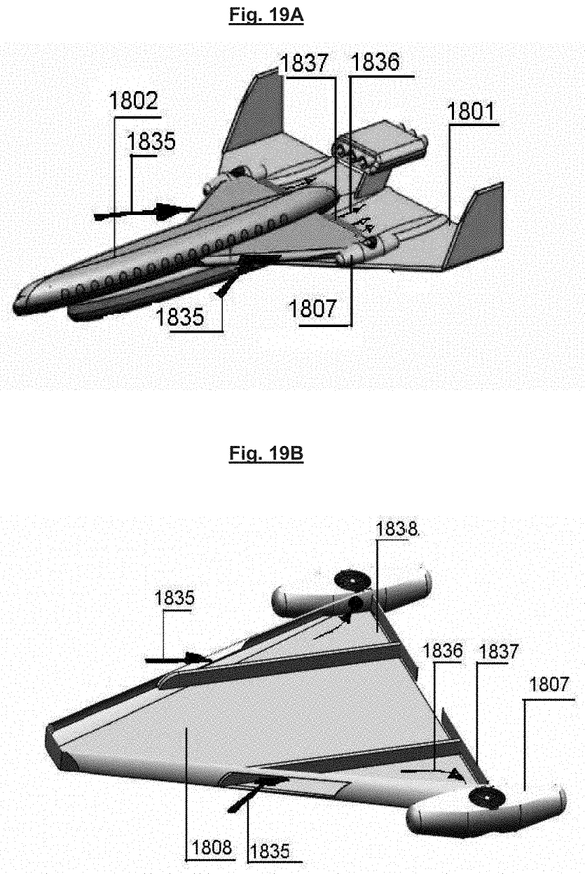

According to some embodiments of the present invention, A wing of a detachable pilotable capsule may have a delta-shaped structure, which, according to some of these embodiments, may be divided into three functional inner sections. This scheme and structure of the wing are shown in FIGS. 19A and 19B. As can be seen, the wing structure includes cavities located at both sides of the wing, designed to allow free air flow during the normal flight 1836 and 1838. FIGS. 19A and 19B show the scheme of controlled air-flow from 35 to 36 or 35 to 38 on the other side. according to further embodiments, The air flow outlet may be controlled by doors 1837. Such a configuration provides for the increase of air speed at the outlet. The boundary layer is blown from the carrier wing, thus increasing its lift and decreasing the wave drag. In this manner, both capsule weight and fuel consumption of the capsule may be partially or fully compensated.

According to some embodiments, in cases of emergency conditions the doors 1837 may be closed, thereby causing the air flow to change its direction to inlets of turbofans 1807. This may cause a turbine of the turbofan to start spinning, allowing the turbofans to become operative at the moment of emergency detachment of the capsule. A process as described above may be automatic. As an option, inlet ports for the air flow may be equipped with movable doors, which can control a volume of incoming air until inlet ports are completely closed. Guides for incoming air may be installed inside the wing in order to straighten and correct the air flow. The air intake from the wing may be used for various aircraft needs, such as the air conditioning system.

According to some embodiments, an additional RAT (ram air turbine) may be located in the wing cavities (creating an alternative/extra electric power supply).

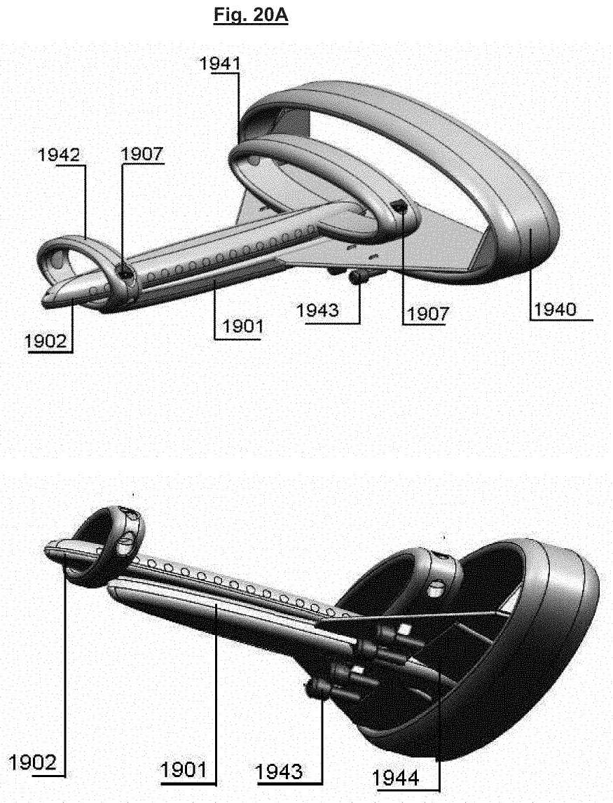

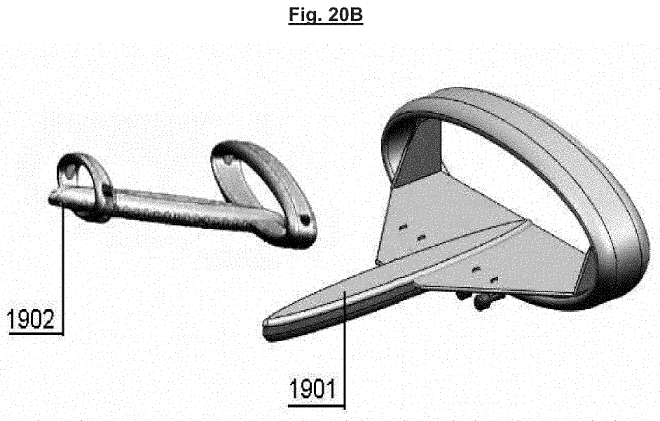

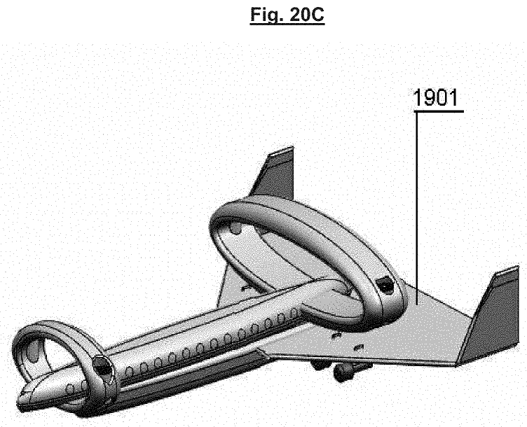

According to some embodiments of the present invention, configurations of aircrafts including detachable pilotable capsules and annular airfoils may be provided. Such embodiments are presented in FIGS. 20A-20C.

FIGS. 20A and 20B present an exemplary compound aircraft with annular (oval) airfoils both on the carrier and the capsule. Since wing panels of the annular airfoil are joined at their tops and bottoms having neither wing tips, nor rotational cores, the wing induced drag is decreased. Besides, this type of wing can produce additional lift, since an airflow passing through the airfoil outline contour is directed downward. This effect is more evident when the angle of attack is larger. In aviation, when the AoA is large, an airflow breakdown can occur, when, due to the AoA increase, the air cannot streamline the upper surface of the wing, producing vortices. In this situation the lift disappears on the wing, causing the structure to lose control. The annular airfoil, however, allows a large (up to 500) angle of attack. Capability of flight at large AoAs allows an aircraft to operate at low speeds without using flaps. Further, annular airfoil aircrafts have no high-lift devices, as the annular outline contour of the wing is stronger than the planar structure.

Looking to FIG. 20A, it can be seen that in this exemplary annular aircraft structure, the detachable pilotable capsule includes annular airfoils 1941 & 1942, located to the front and rear. Fuel for turbofans 1907 is located on the upper section of the wings 1941 & 1942, while emergency air for passengers in the autonomous flight is located in their lower section. The annular airfoil of the carrier 1940 acts as a standard lifting surface. The carrier engines 1943 are located beneath the carrier structure.

Underwing flaps 1944 are installed in the lower section of the standard wing of the carrier. They are lowered during the take-off, deflecting jets from the engines 1943, thus allowing to decrease a takeoff run.

When the detachment of the capsule 1902 from the carrier 1901 is desired, this process can be performed at large angles of attack, which can be critical in emergency conditions.

Two exemplary configurations of aircrafts with annular airfoil and pilotable capsules are as follows:
1. configurations with annular airfoils both on the carrier and pilotable capsule, as shown in FIGS. 20A and 20B, wherein 20A shows the structure prior to separation and 20B after;
2. configurations with annular airfoils on the pilotable capsule and standard airfoils on the carrier, as shown in FIG. 20C.

Looking to FIG. 20C, this design has the following advantages
1. This configuration has no backwash, which increases airport capacity due to a significant decrease of the distance needed between aircrafts.
2. An increase in the effective load of the aircraft
3. An increase of aircraft stability
4. An increase of crosswind stability
5. A capability to avoid stalling at large angles of attack
6. An increased capability to glide with engines off

An AoA of an annular airfoil can be up to 500, while competing aircraft can reach no more than 20-22°. Air within the closed airfoil can prevent airflow breakdown from the upper surface of the lower section of the wing. When an airflow exits the airfoil outline contour due to ejection (a process of mixing of two media, one of them is entrained by other), it entrains an airflow that passes on the upper surface of the upper section of the wing. Further data related to the advantages of the annular airfoil can be found at: http://yablor.ru/blogs/samolet-s-kolcevim-krilom/2998600.

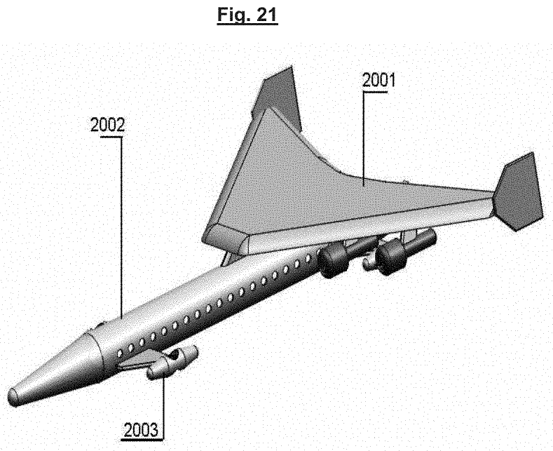

According to further embodiments, aircrafts having detachable pilotable capsules having relatively small/short wings (or with inflatable or retractable wings) may be provided. Such embodiments may have 2 or more pairs of left and right wings. Illustrations of examples of such embodiments are presented in FIGS. 21-25. It should be noted that the same embodiments can be implemented with more pairs of wings. Clearly these embodiments reduce the weight of the capsule and thus, also of the aircraft.

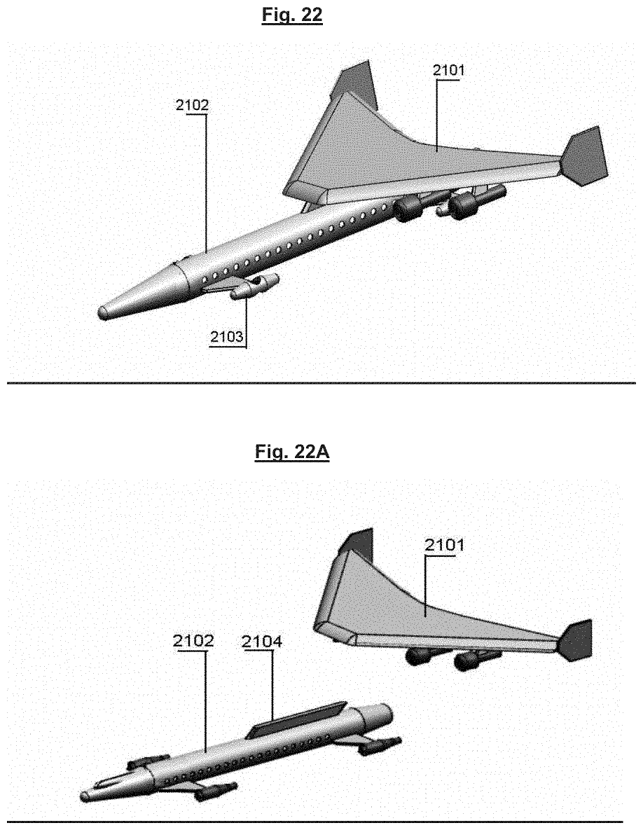

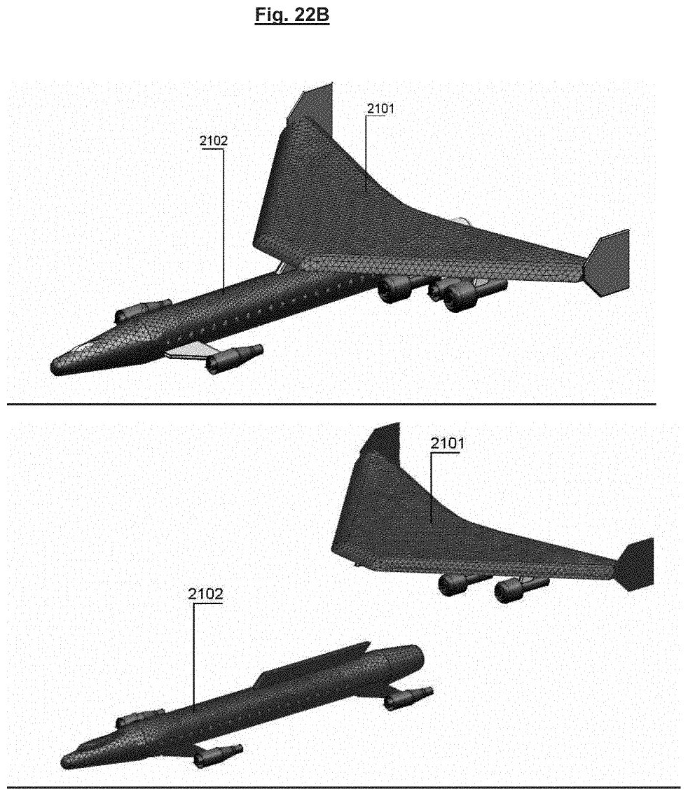

Looking at FIGS. 21, 22, 22A & 22B it can be seen that these exemplary aircrafts are comprised of a carrier 2001 of flying wing type and a pilotable capsule 2002. FIG. 21 shows the passenger capsule with lift turbofans, whereas FIGS. 22, 22A & 22B show this structure with lift-cruise turbofans. The carrier without a fuselage and the simplified empennage in comparison with other embodiments of this description reduce the weight of this structure. Further, maintainability of this structure is increased, thus decreasing its cost.

FIG. 22A shows a moment of system detachment in an emergency condition. Detachment of the capsule in these embodiments is very stable, as is demonstrated by FIG. 22B, which show load/weight distribution in assembled condition and in detached condition. A joining element of the two parts is pylon 2004, that acts as a stabilizer after the capsule has been detached.

FIG. 23 shows a similar embodiment having a low-mounted wing. This demonstrates a high flexibility of this structural scheme.

In addition to aircraft weight reduction, this structure has other advantages, including:
1. A possibility to perform landing of the pilotable capsules in areas that are not equipped with any aerodrome. The carrier 2001 can be reused after its standard detachment from the passenger module. For this purpose the carrier can be equipped with a system that can perform its safe landing after its standard detachment
2. A possibility to use/manufacture a single carrier for different types of capsules.
3. Facilitation of transportation and storage of the pilotable capsule apart from the carrier
4. The simplified structure and the decreased weight of the carrier reduces risk and effects of a carrier crash.

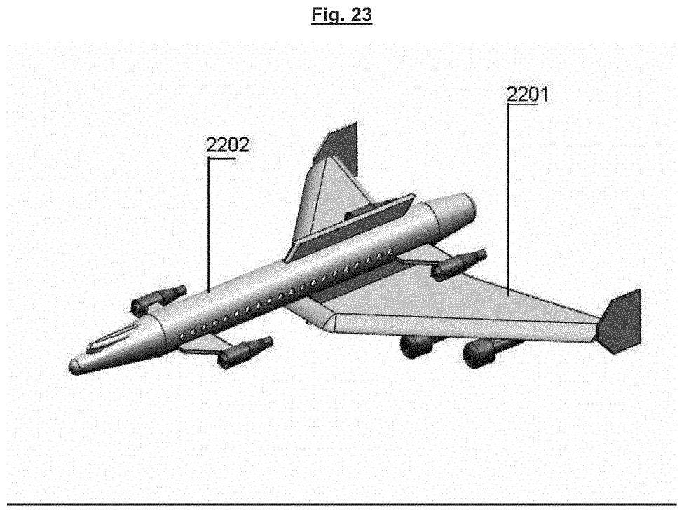

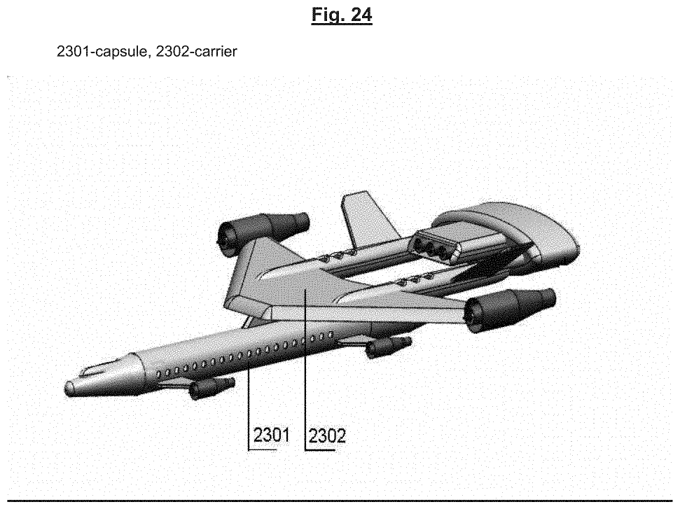

According to some embodiments, a configuration of an aircraft including a detachable pilotable capsule and vertical take-off capabilities may be provided. Illustrations of an example of such embodiments are shown in FIGS. 24, 24A and 24B. FIG. 24 shows the entire aircraft, including both the Carrier 2301 and the capsule 2302 in the attached position. FIG. 24A shows the Carrier separately; as can be seen this exemplary carrier of an aircraft including a detachable pilotable capsule and vertical take-off capabilities includes: a wing structure 2310, a fuselage with turbofans 2320, a tail assembly 2330, jet engines 2340, a receiver 2350 and electrically driven fans 2360. FIG. 24B shows the pilotable capsule separated from the Carrier. According to some embodiments, a receiver 2350 may accumulate the exhaust gases from engines during the vertical take-off. The gases may be redirected to turbofans for vertical thrust generation.

The configurations exemplified in FIGS. 24, 24A and 24B have three main advantages:
1—The possibility of vertical take-off and landing;
2—Exhaust gases from the engines may enter the receiver 2306 which may then use them for turbofan actuation. This solution can save fuel and protect the environment by reducing the amount of exhaust fumes; and
3—Low noise levels.

FIGS. 25A and 25B present yet another embodiment of the present invention. In these figures the carrier is marked 2402, the detachable pilotable capsule 2401, Turbo jet engines with generators 2403, which provide power to accumulators of vectored-thrust ventilators 2404. Each vectored-thrust ventilator may be equipped with an electrical actuator which can change the ventilator orientation from 0° to 90°. FIG. 25B shows the moment immediately following detachment of the pilotable capsule. In this figure the angled position of the turbofans 2404 can be seen, as well as further turbofans 2405. After detachment the pilotable capsule may perform a vertical landing using the vectored-thrust ventilators. This aircraft configuration has the following advantages:

1—the possibility of performing vertical take-off and landing of the entire aircraft or the detached capsule alone;
2—weight minimization and simplicity.

It should be understood by one of ordinary skill in the art, that the above described combination of discreet elements is one of many possible combinations of elements possible to fabricate an aircraft wing spar or any other structural element desired, in accordance with the principles of this invention.

It should also be understood by one of skill in the art that some of the functions described as being performed by a specific component of the system may be performed by a different component of the system in other embodiments of this invention.

The present invention can be practiced by employing conventional tools, methodology and components. Accordingly, the details of any such tool, component and methodology are not set forth herein in detail. In the previous descriptions, numerous specific details are set forth, in order to provide a thorough understanding of the present invention. However, it should be recognized that the present invention may be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An aircraft including a detachable capsule, said aircraft comprising:
a pilotable capsule comprising:
one or more turbo-fans adapted to facilitate independent flight of said pilotable capsule;
said turbo-fans being comprised of a uniplanar centrifugal fan fixedly connected to a turbine;
independent gas generators configured to actuate said turbine; and
controllable doors or shutters positioned at outlets of said turbo-fans and adapted to control direction of thrust produces by said turbo-fans;
said carrier structure comprising:
one or more engines and wings adapted to jointly facilitate flight of said carrier structure while said pilotable capsule is attached to said carrier structure; and
an attachment mechanism adapted to secure said pilotable capsule to said carrier during flight and release said pilotable capsule from said carrier in midflight.
